(19) United States
(12) Patent Application Publication
(10) Pub. No.: US 2025/0328580 A1
(43) Pub. Date: Oct. 23, 2025

(54) SEARCH SYSTEM AND SEARCH METHOD

(71) Applicant: Hitachi, Ltd., Tokyo (JP)

(72) Inventors: Yuki WATANABE, Tokyo (JP); Yi HE, Tokyo (JP); Tatsuya SASAKI, Tokyo (JP); Atsushi HIROIKE, Tokyo (JP); Daisuke YOSHIDA, Tokyo (JP)

(21) Appl. No.: 19/077,422

(22) Filed: Mar. 12, 2025

(30) Foreign Application Priority Data
Apr. 23, 2024 (JP) 2024-070015

(51) Int. Cl. G06F 16/532; G06F 16/535; G06F 16/538; G06T 15/20; G06V 20/64

(52) U.S. Cl. CPC G06F 16/532; G06F 16/535; G06F 16/538; G06T 15/20; G06V 20/64

(57) ABSTRACT

A search system includes: a 3D object generation unit configured to generate an input 3D object from an input image; an image generation unit configured to generate, as a search image group, a plurality of images obtained by viewing the input 3D object from a plurality of viewpoints; an image feature extraction unit configured to calculate an image feature from each of the images in the search image group; an image search unit configured to search, by using each of the images in the search image group as a search query, a database in which a plurality of images obtained by viewing a plurality of 3D objects as search targets from a plurality of viewpoints are registered; and an image search result integration unit configured to integrate a search result for each of the images in the search image group for each of the 3D objects as the search targets.

### CROSS-REFERENCE TO RELATED APPLICATION

The present application claims priority from Japanese application JP2024-070015, filed on Apr. 23, 2024, the content of which is hereby incorporated by reference into this application.

### BACKGROUND OF THE INVENTION

### 1. Field of the Invention

The present invention relates to a search system and a search method for searching for a 3D object.

### 2. Description of Related Art

With the spread of a computer aided design (CAD) technique and software, a use of three dimension (3D) data is becoming more widespread in product design and manufacturing, building construction, and other areas. Since these 3D data are digital data, these 3D data can be easily stored, and there is a need to efficiently search for a large amount of accumulated 3D data. Further, if it is possible to search for 3D data that is similar in appearance not only by using bibliographic information accompanying the 3D data, but also by using a single image such as a sketch or photograph from an idea stage as a clue, it is possible to accelerate the use of the 3D data, such as improving work efficiency in early design stages and searching for related information from on-site photographs.

A similar image search technique is known as a method of finding images that are similar in appearance from a database. In the similar image search, an image feature representing a color, a shape, or the like is calculated as a numerical vector from an image, and images having a short distance between vectors are searched in the database. In recent years, searching accuracy has been improved by calculating the image feature using large-scale datasets and deep learning. On the other hand, since the appearance of the 3D data varies greatly depending on a viewpoint, it is difficult to search for similar 3D data using a single image as a clue.

With respect to such a search for the 3D data, an object search device in Patent Literature 1 includes an image feature extraction unit that is formed by a first neural network and inputs an image to extract image features, a three-dimensional data feature extraction unit that is formed by a second neural network and inputs three-dimensional data to extract a three-dimensional data feature, a learning unit that extracts an image feature and a three-dimensional data feature from an image and three-dimensional data of an object that are obtained from a same individual, respectively, and updates an image feature extraction parameter so as to reduce a difference between the image feature and the three-dimensional data feature, and a search unit that extracts image features of a query image and a gallery image of the object by the image feature extraction unit using the updated image feature extraction parameter, and calculates a similarity between the image features of both images to search for the object. Accordingly, there is provided an object search device capable of expressing information on shapes and irregularities as features only by images, in a search for an object that is characteristic in shape or irregularity, and performing an accurate search.

On the other hand, with development of deep learning, a method for automatically generating an image from simple input such as a sentence or a simple sketch has been rapidly developed. For example, a method for generating an image using a diffusion model and a method for generating a 3D object using a sentence or an image as input are known.

### CITATION LIST

### Patent Literature

Patent Literature 1: JP7196058B

### SUMMARY OF THE INVENTION

The related art disclosed in Patent Literature 1 has two main problems. The first problem is that training data is required for feature learning of an image and three-dimensional data. In this case, new training data is required each time a new type of 3D object or image is added to a database. This is very labor intensive, and it is impractical to provide enough training data to cover all possibilities.

Secondly, the device in Patent Literature 1 has a problem in that the user cannot check or control an intermediate result. The user has no choice but to directly use a search result, and it is difficult for the user to check a basis such as which part of the image and the three-dimensional data is similar to the search result, or to perform a specific instruction or adjustment and apply feedback to a search query to perform a research.

For these reasons, there is a demand for a highly convenient search system that can provide search feedback without a learning load in searching for a 3D object.

In order to solve the above problems, one representative search system according to the invention includes:
a 3D object generation unit configured to generate an input 3D object from an input image;
an image generation unit configured to generate, as a search image group, a plurality of images obtained by viewing the input 3D object from a plurality of viewpoints;
an image feature extraction unit configured to calculate an image feature from each of the images in the search image group;
an image search unit configured to search, by using each of the images in the search image group as a search query, a database in which a plurality of images obtained by viewing a plurality of 3D objects as search targets from a plurality of viewpoints are registered; and
an image search result integration unit configured to integrate a search result for each of the images in the search image group for each of the 3D objects as the search targets, and output, as a similar 3D object, a 3D object similar to the input image among the 3D objects as the search targets.

One representative search method according to the invention includes:
by a search device,
a 3D object generation step of generating an input 3D object from an input image;
an image generation step of generating, as a search image group, a plurality of images obtained by viewing the input 3D object from a plurality of viewpoints;
an image feature calculation step of calculating an image feature from each of the images in the search image group;
an image search step of searching, by using each of the images in the search image group as a search query, a database in which a plurality of images obtained by viewing a plurality of 3D objects as search targets from a plurality of viewpoints are registered; and
an image search result integration step of integrating a search result for each of the images in the search image group for each of the 3D objects as the search targets, and outputting, as a similar 3D object, a 3D object similar to the input image among the 3D objects as the search targets.

According to the invention, a highly convenient 3D object search can be achieved. Problems, configurations, and effects other than those described above will become apparent by the following description of embodiments.

### BRIEF DESCRIPTION OF THE DRAWINGS

FIG. 1 is a block diagram showing a configuration of a 3D object generation and search system;

FIG. 2 is a block diagram showing a hardware structure of the 3D object generation and search system;

FIG. 3 is a diagram showing a structure of a 3D object and image database;

FIG. 4 is a diagram illustrating generation and search of multi-viewpoint images;

FIG. 5 is a flowchart showing a database registration process;

FIG. 6 is a flowchart showing a database search process;

FIG. 7 is a diagram showing an example of a screen of the 3D object generation and search system;

FIG. 8 is a sequence diagram showing an overall process of the 3D object generation and search system;

FIG. 9 is a diagram illustrating representative image selection performed by clustering;

FIG. 10 is a flowchart showing a representative image selection process performed by the clustering;

FIG. 11 is a diagram illustrating the representative image selection using a feature distribution;

FIG. 12 is a flowchart showing the representative image selection process using the feature distribution;

FIG. 13 is a diagram illustrating weighting of search results according to camera positions;

FIG. 14 is a flowchart showing a weighting process of the search results according to the camera positions;

FIG. 15 is a diagram illustrating verification of camera position relationships of the search results;

FIG. 16 is a flowchart showing a verifying process of the camera position relationships of the search results;

FIG. 17 is a diagram illustrating image generation performed by multi-modal/multi-object; and

FIG. 18 is a flowchart showing an image generation process performed by the multi-modal/multi-object.

### DESCRIPTION OF EMBODIMENTS

Hereinafter, embodiments of the invention will be described with reference to the accompanying drawings. The present embodiments are merely examples for implementing the invention, and do not limit the technical scope of the invention. In the drawings, the same reference numerals are given to the same configurations.

### First Embodiment

In a registration phase, a 3D object generation and search device 104 according to the present embodiment generates images of a plurality of viewpoints from an input 3D object, extracts an image feature from each of the images of the plurality of viewpoints, and registers the image features in a 3D object and image database 112. In a search phase, a 3D object is generated from an input image, images of a plurality of viewpoints are generated from the 3D object, similar images are searched from the 3D object and image database 112 with image features extracted from the images of the plurality of viewpoints, and search results are integrated to output similar 3D objects. Accordingly, it is possible to accurately search for the similar 3D objects from one image.

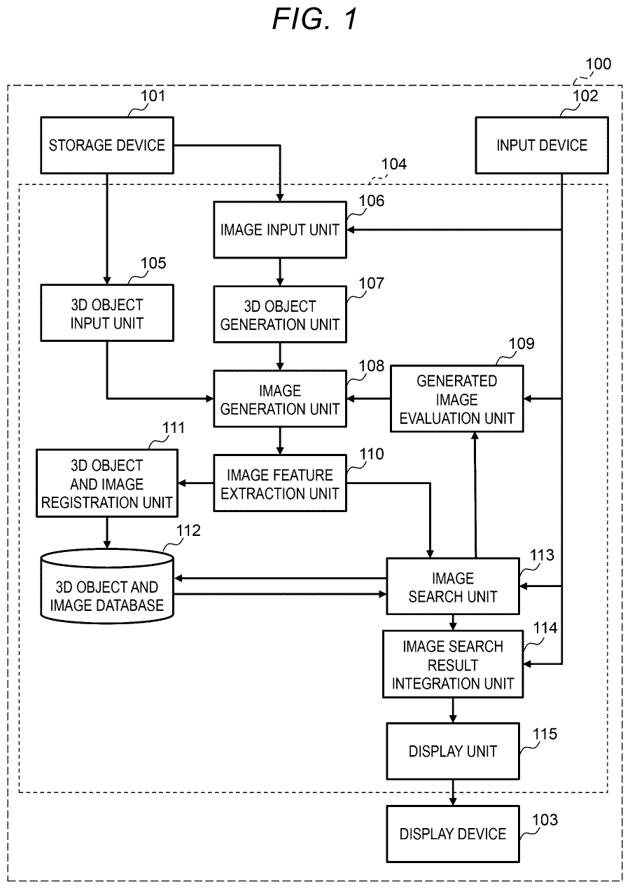

FIG. 1 is a block diagram showing a configuration example of a 3D object generation and search system 100 according to a first embodiment. Use cases for the 3D object generation and search system 100 include searching for 3D data used in product design and building construction, but are not limited to this. Search targets stored in the database do not necessarily have to be the 3D data, but may be only images. Hereinafter, each configuration will be described.

The 3D object generation and search system 100 generates images of a plurality of viewpoints from a 3D object input by a user and registers the images in the 3D object and image database 112. Further, the 3D object is generated from the image input by the user, the images of the plurality of viewpoints are generated from the 3D object, similar images of each of the images are searched from the 3D object and image database 112, and search results are integrated to output the similar 3D objects. The 3D object generation and search system 100 includes a storage device 101, an input device 102, a display device 103, and the 3D object generation and search device 104.

The storage device 101 is a storage medium that stores still image and video data or bibliographic k information associated with the still image and video data, and is formed by using a hard disk drive built into a computer, or a storage system connected via a network, such as a network attached storage (NAS) or a storage area network (SAN). Further, the storage device 101 may be a cache memory that temporarily holds data continuously input from an imaging device such a camera.

The input device 102 is an input interface such as a mouse, a keyboard, or a touch device for transmitting a user operation to the 3D object generation and search device 104. The display device 103 is an output interface such as a liquid crystal display, and is used for displaying the search results of the 3D object generation and search device 104, an interactive operation with the user, and the like.

The 3D object generation and search device 104 is a device that performs a registration process of inputting the 3D objects as the search targets into the database, and a search process of acquiring the 3D objects similar to the image input by the user from the database.

The 3D object generation and search device 104 includes a 3D object input unit 105, an image input unit 106, a 3D object generation unit 107, an image generation unit 108, a generated image evaluation unit 109, an image feature extraction unit 110, a 3D object and image registration unit 111, the 3D object and image database 112, an image search unit 113, an image search result integration unit 114, and a display unit 115.

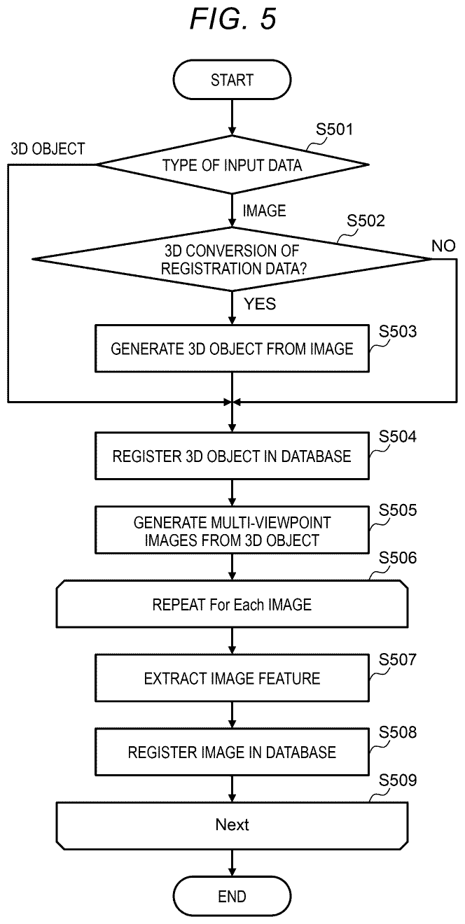

Hereinafter, the database registration process will be described. Details of the process will also be described with reference to a flowchart in FIG. 5.

In the database registration process, processing for enabling a search for the 3D objects read from the storage device 101 is performed. In this process, images are generated when each of the input 3D objects is rendered from a plurality of viewpoints in a 3D space, and a feature for a similar image search is extracted from each of the images and registered in the 3D object and image database 112.

The 3D object input unit 105 receives input of 3D object data from the storage device 101 and converts the 3D object data into a data format used within the 3D object generation and search device 104. The data format includes, for example, (1) a point cloud, which is a collection of points in a 3D space; (2) a mesh formed by vertices, edges, and faces; (3) voxels, which are obtained by dividing a 3D space into small cubes of a certain volume; and (4) neural radiance fields (NeRF), which represents a color and density corresponding to a point in a 3D space. However, any format can be used as long as an image can be rendered as seen from a specified viewpoint.

The image generation unit 108 generates one or more images by providing the 3D object acquired by the 3D object input unit 105 on the 3D space, providing a camera at one or more predetermined positions, and performing rendering. If necessary, the rendering may be performed by changing a material, a light source, and a background of the 3D object.

The image feature extraction unit 110 extracts one or more types of image features for each of all the images generated by the image generation unit 108. The image feature is numerical data representing a color and a shape of the image, and is usually given as fixed-length vector data. Similarity between two original images can be obtained by calculating Euclidean distance between two vectors, Cosine similarity, and the like. By extracting a plurality of types of image features, it is also possible to determine the similarity from different viewpoints in accordance with a user instruction.

The 3D object and image registration unit 111 associates the 3D object acquired by the 3D object input unit 105 with multi-viewpoint images which are generated by the image generation unit 108 and in which features are calculated by the image feature extraction unit 110, and adds data to the 3D object and image database 112.

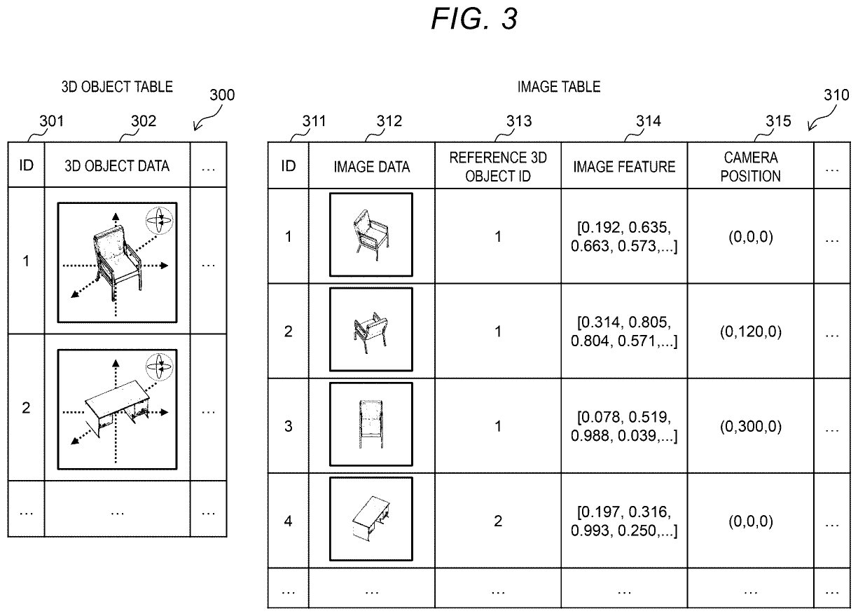

The 3D object and image database 112 holds the input 3D objects, the generated multi-viewpoint images, and the features thereof. The 3D object and image database 112 can search for registration data satisfying a given condition or read data of a designated ID in response to an inquiry of each unit of the 3D object generation and search device 104. Further, by calculating a similarity between a feature of a query image and a feature of each of registered images, it is possible to perform a similar image search for sorting and outputting the registered images in descending order of similarity. Details of a structure of the 3D object and image database 112 will be described later with reference to FIG. 3.

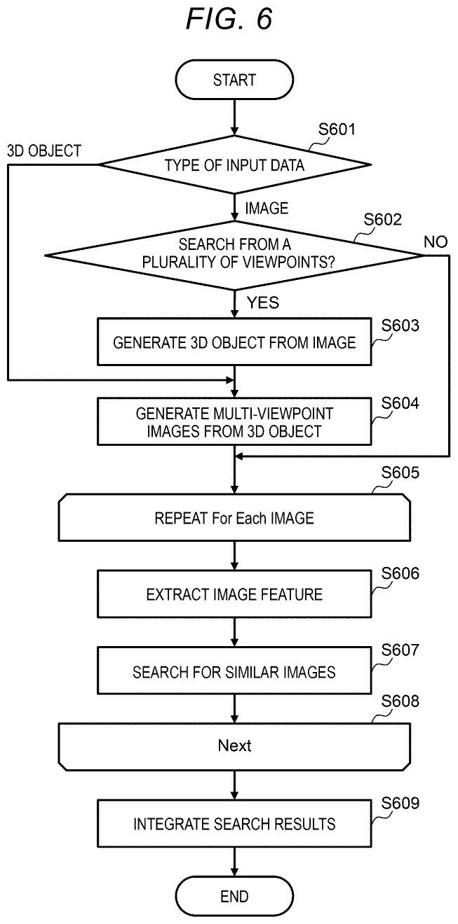

The above is operation of each unit in the database registration process of the 3D object generation and search device 104. Next, operation of each unit in the search process of the 3D object generation and search device 104 will be described. The image generation unit 108 and the image feature extraction unit 110 have been described in the registration process, but are also used in the search process. Details of the process will also be described with reference to a flowchart in FIG. 6.

In the database search process, using a search condition specified by the user via the input device 102, images matching the search condition are searched for in the 3D object and image database 112, and information is presented on the display device 103. The user can obtain the similar 3D objects by specifying an image.

The image input unit 106 receives input of the still image data or the video data from the storage device 101, and converts the input data into a data format to be used in the 3D object generation and search device 104. For example, when data received by the image input unit 106 is the video data, the image input unit 106 performs a video decoding process of disassembling the video data into frames (still image data format). Further, if stroke information is input using a mouse or a touch device, the stroke information is drawn on an image.

The 3D object generation unit 107 automatically generates the 3D object from the image using a 3D object generation model. As the 3D object generation model, any algorithm or learned model can be used. Further, an algorithm can be used for generating the 3D object from a sentence, and the sentence can be used instead of an image.

The image generation unit 108 generates one or more images by providing the 3D object acquired by the 3D object generation unit 107 on the 3D space, providing the camera at one or more predetermined positions, and performing rendering. As a method related to a method for generating the 3D object from the image, there is a method for generating images of a plurality of different viewpoints from one image. When this method is used, output equivalent to those of the 3D object generation unit 107 and the image generation unit 108 can be obtained. However, the user cannot check the 3D object on the screen or adjust the generated images by changing a camera position or a rendering condition.

The generated image evaluation unit 109 selects images to be used for search from the multi-viewpoint images generated by the image generation unit 108. The 3D object automatically generated from one image can be seen from various angles, and images having high generation quality and matching a purpose are selected. An evaluation may be performed based on a direct instruction from the user who checks the generated images, or may be performed automatically using a heuristic method or an evaluation model based on machine learning. Here, selecting the images that match the purpose means, in other words, eliminating images from the search. Images in which a feature of the object appears are selected, and images in which the feature of the object does not appear are removed. The images may be selected at the time of registration or at the time of search.

The image feature extraction unit 110 calculates an image feature of a type specified by the user for each of all the images generated by the image generation unit 108 and selected by the generated image evaluation unit 109. Examples of the type of image feature that can be specified by the user include a shape, a color, and a size.

The image search unit 113 searches for an image group registered in the 3D object and image database 112 based on the image features calculated by the image feature extraction unit 110. Search results are sorted in descending order of similarity and output, and include information such as an image ID, a similarity, and a 3D object ID. However, for the same 3D object, only an image having the highest similarity appears in the search result. Since the images from the plurality of viewpoints are used, the search process is performed a plurality of times to obtain a plurality of search results.

The image search result integration unit 114 integrates the plurality of search results obtained from the image search unit 113 and outputs an integrated result as a final search result. In the integration method, for example, scores of similarities in the search results are added up for each 3D object. Accordingly, a similarity of the 3D object can be obtained as a total value of the similarities of the multi-viewpoint images. Finally, the search results are output after being sorted in descending order of similarities of the 3D objects.

The display unit 115 outputs data for displaying, on the display device 103, a processing result of each unit of the 3D object generation and search device 104. For example, the image input by the user through the image input unit 106, the 3D object generated through the 3D object generation unit 107, the multi-viewpoint images generated through the image generation unit 108, the search result for each of the images obtained through the image search unit 113, the similar 3D objects obtained through the image search result integration unit 114, and the like are displayed on the display device 103.

The above is the operation of each unit in the search process of the 3D object generation and search device 104. The registration process and the search process of the 3D object generation and search device 104 are processes repeatedly performed by the instruction of the user, a content of the 3D object and image database 112 is sequentially added and updated, and a processing content of each unit using the registration data changes accordingly. Further, if exclusive control of a database update is performed appropriately, a plurality of users can also access and use the database simultaneously.

Although the case in which the input in the database registration process is the 3D object and the input in the database search process is the image has been described above, the present system can be used in any combination. For example, an image can be received in the registration process, and a 3D object generated by the 3D object generation unit 107 can also be registered in the database. Further, for example, it is also possible to receive a 3D object as a query in the search process and perform a search using rendering images from a plurality of viewpoints.

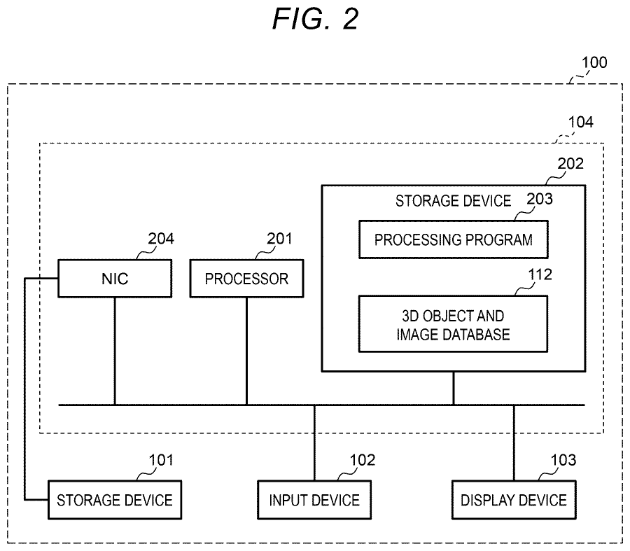

FIG. 2 is a block diagram showing a hardware structure example of the 3D object generation and search system 100 of the present embodiment. The 3D object generation and search device 104 includes a processor 201 and a storage device 202 connected to each other. The storage device 202 includes any type of storage medium. The storage device 202 includes, for example, a combination of a semiconductor memory as a main storage device and a hard disk drive as an auxiliary storage device.

Functional units such as the 3D object input unit 105, the image input unit 106, the 3D object generation unit 107, the image generation unit 108, the generated image evaluation unit 109, the image feature extraction unit 110, the 3D object and image registration unit 111, the image search unit 113, the image search result integration unit 114, and the display unit 115 illustrated in FIG. 1 are achieved by the processor 201 executing a processing program 203 stored in the storage device 202. In other words, processing executed by each of the functional units is executed by the processor 201 based on the processing program 203. Further, the data of the 3D object and image database 112 is stored in the storage device 202. When the 3D object generation and search system 100 includes a plurality of devices for the purpose of processing load distribution or the like, a device including the 3D object and image database 112 and a device executing the processing program 203 may be physically different devices connected via a network, or the processing program 203 may be executed simultaneously on the plurality of devices as long as a consistency of data recorded in the 3D object and image database 112 can be maintained.

The 3D object generation and search device 104 further includes a network interface device (NIC) 204 connected to the processor 201. The storage device 101 is assumed to be a NAS or a SAN connected to the 3D object generation and search device 104 via the network interface device 204. The storage device 101 may be provided in the storage device 202.

FIG. 3 is a diagram illustrating a configuration and a data example of the 3D object and image database 112 according to the present embodiment. In the present embodiment, information used by the system may be expressed by any data structure without depending on the data structure. FIG. 3 shows examples in a table format, and information can be stored in a data structure appropriately selected from, for example, a table, a list, a database or a queue.

The 3D object and image database 112 includes, for example, a 3D object table 300 and an image table 310. Table configurations and field configurations of the tables in FIG. 3 are examples, and the tables and the fields may be added according to an application, for example. The table configuration may be changed as long as the same information is held.

The 3D object table 300 includes a 3D object ID field 301 and a 3D object data field 302.

The 3D object ID field 301 holds an identification number of the 3D object. A 3D object data field 303 holds data of the 3D object. The 3D object is held in any text or binary format such as a point cloud, a mesh, a voxel, or a NeRF model. A file path may be a file path on a file storage as long as the data of the 3D object can be accessed.

The image table 310 includes an image ID field 311, an image data field 312, a reference 3D object ID field 313, an image feature field 314, and a camera position field 315.

The image ID field 311 holds an identification number of the 3D object. The image field 312 holds binary data of an image. A file path may be a file path on the file storage as long as the binary data of the image can be accessed. The reference 3D object ID field 313 refers to the 3D object as a rendering source of the image, and holds a 3D object ID managed by the 3D object table 300. The image feature field 314 holds a numerical vector representing a feature extracted from the image. The camera position field 315 holds position information of a camera on the 3D space when the image is rendered. For example, when the 3D object is provided at an origin on the 3D space and the camera is directed toward the 3D object from a position separated by a predetermined distance, the position can be defined by three values of a rotation angle of the camera with respect to X, Y, and Z axes. In addition, any numerical value may be used as long as the position of the camera on the 3D space is uniquely determined.

Fields may be added to the 3D object table 300 and the image table 310 as necessary. For example, a time at which the data is registered, a tag for the data, and the like may be added to narrow down the data at the time of search. Further, a plurality of fields may be prepared for the feature field 314, and results of calculations using a plurality of feature extraction methods may be stored, allowing the user to select which feature to use during the search.

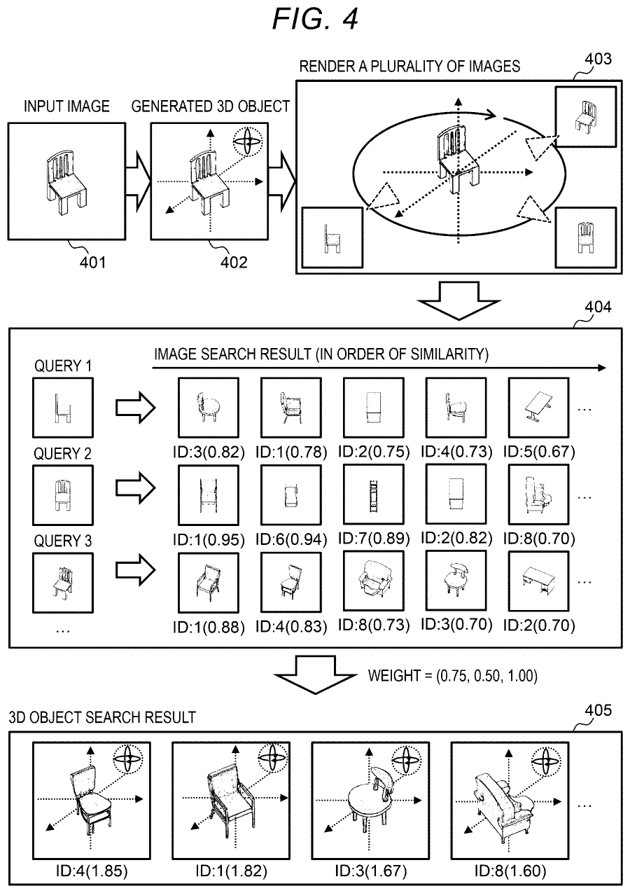

FIG. 4 is a diagram illustrating an outline of 3D object generation from the image and 3D object search using the multi-viewpoint images according to the present embodiment. When the user gives an image as a search query, an input image 401 is converted into a 3D object by the 3D object generation unit 107. A known algorithm can be used for the 3D object generation. The generated 3D object 402 is developed on the 3D space by the image generation unit 108, and is converted into images of a plurality of viewpoints by rendering from a plurality of camera positions. A feature of each of multi-viewpoint images 403 is calculated by the image feature extraction unit 110 and becomes a query in an image search, and search results of the 3D object and image database are obtained by the image search unit 113. An ID in a lower part of each of search result images in the drawing is an ID of the 3D object associated with the image held in the reference 3D object ID field 313. The number in parentheses is a similarity to the query image. An image search result 404 is integrated by the image search result integration unit 114 into a search result 405 for each 3D object. The search result 405 of the 3D object is output by sorting results in descending order of total similarity obtained by adding up the similarities of all the images in the image search result 404 for a certain 3D object. When a total value is calculated, a weight may be assigned to each query. For example, in FIG. 4, similarities of search results for a query 1 are multiplied by 0.75, similarities of search results for a query 2 are multiplied by 0.50, and similarities of search results for a query 3 are multiplied by 1.00, and then added up as the total similarities.

FIG. 5 is a diagram showing a process flow of database registration. Hereinafter, each step in FIG. 5 will be described.

The 3D object generation and search device 104 determines a type of input data, and if the input data is the 3D object, executes step S504 after reading by the 3D object input unit 105, and if the input data is an image, executes step S502 after reading by the image input unit 106 (S501).

The 3D object generation and search device 104 executes step S503 if it is necessary to convert the registration data into 3D, and executes step S504 if not (S502).

The 3D object generation unit 107 generates the 3D object from the image input in step S501 (S503).

The 3D object and image registration unit 111 registers the 3D object input in step S501 or the 3D object generated in step S503 in the 3D object and image database 112. Accordingly, the ID of the 3D object is issued (S504). However, in step S502, when only one image is input and the 3D conversion is unnecessary, one input image is registered in the database as a pseudo 3D object.

The image generation unit 108 provides the 3D object input in step S501 or the 3D object generated in step S503 in the 3D space, and generates the multi-viewpoint images by rendering from cameras at the plurality of positions (S505). However, in step S502, when only one image is input and the 3D conversion is unnecessary, only one input image is output.

The 3D object generation and search device 104 executes step S507 and step S508 for each of the images generated in step S505 (S506).

The image feature extraction unit 110 calculates the image feature from the image (S507).

The 3D object and image registration unit 111 registers image data and the image features extracted in step S507 in the 3D object and image database 112. At this time, the 3D object ID issued in step S504 is registered as the reference 3D object ID (S508).

When the process has been executed for all the images, the 3D object generation and search device 104 ends the database registration process (S509).

FIG. 6 is a diagram showing a process flow of the database search. Hereinafter, each step in FIG. 6 will be described.

The 3D object generation and search device 104 determines a type of the input data, and if the input data is the 3D object, executes step S604 after reading by the 3D object input unit 105, and if the input data is the image, executes step S602 after reading by the image input unit 106 (S601).

The 3D object generation and search device 104 executes step S603 when the search is performed using the multi-viewpoint images, and executes step S605 if not (S602). The user may specify whether to perform a search using the images from the plurality of viewpoints.

The 3D object generation unit 107 generates the 3D object from the image input in step S601 (S603).

The image generation unit 108 provides the 3D object input in step S601 or the 3D object generated in step S603 in the 3D space, and generates the multi-viewpoint images by rendering from the cameras at the plurality of positions (S604).

The 3D object generation and search device 104 executes step S606 and step S607 for each of the images generated in step S604 (S605).

The image feature extraction unit 110 calculates the image feature from the image (S606).

The image search unit 113 searches the 3D object and image database 112 for the similar images using the image features calculated in step S606 as the queries (S607).

When the search process has been executed for all the images, the 3D object generation and search device 104 executes step S609 (S608).

The image search result integration unit 114 calculates the total similarity for each 3D object with respect to search results of the images obtained in step S607, sorts and outputs the search results in descending order of the total similarity, and ends the database search process (S609).

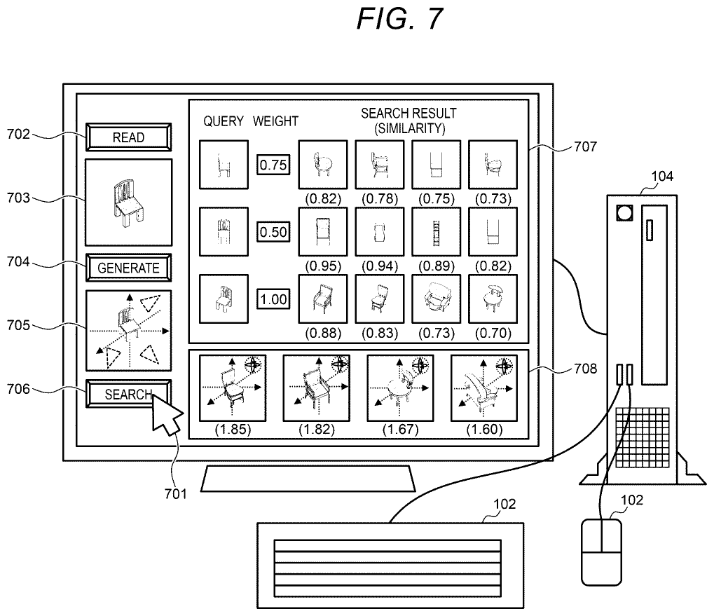

FIG. 7 is a diagram showing a configuration example of an operation screen for performing the database search process in the 3D object generation and search device 104 according to the first embodiment. The 3D object generation and search device 104 displays a processing result on the display device 103. The user transmits operation information to the 3D object generation and search device 104 using the input device 102 and a mouse cursor 701 displayed on a screen. The screen includes a query read button 702, an input image display field 703, a 3D object generation button 704, a 3D object display field 705, a search button 706, an image search result display field 707, and a 3D object search result field 708. The configuration example of the screen is an example, and the screen may be implemented by freely providing these elements.

When the user clicks the query read button 702 to select the data stored in the storage device 101, the query is read into the 3D object generation and search device 104. If the query is the image, the image is displayed in the input image display field 703, and if the query is the 3D object, the query is displayed in the 3D object display field 705. When the user clicks the 3D object generation button while the image is displayed in the input image display field 703, the 3D object is generated from the input image and displayed in the 3D object display field 705. In the 3D object display field 705, the user can view the 3D object from any angle by adjusting the position of the camera. Further, it is possible to specify the camera position used for the image generation and adjust the rendering condition such as a light source. When the search button 706 is clicked, the images of the plurality of viewpoints are generated from the 3D object, the similar image search using each image as the query is executed, and results are displayed in the image search result display field 707. The user can check the search results and adjust a weight used for integrating the search results. A result of integrating the image search results for each 3D object is displayed in the 3D object search result display field 708.

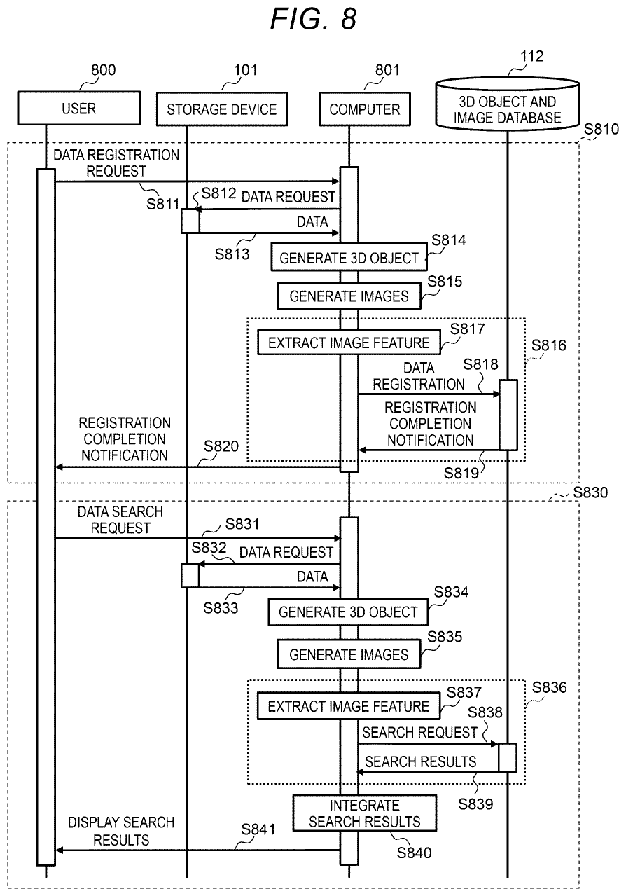

FIG. 8 is a sequence diagram illustrating a process of performing the database registration and the database search in the 3D object generation and search device 104 according to the first embodiment. FIG. 8 specifically shows a processing sequence between a user 800, the storage device 101, a computer 801, and the 3D object and image database 112 in each process of the 3D object generation and search system 100 described above. The sequence in FIG. 8 is roughly divided into the database registration process (S810) described with reference to FIG. 5 and the database search process (S830) described with reference to FIG. 6, and these sequences are repeatedly executed in response to a request from the user 800. The computer 801 is a computer that implements the 3D object generation and search device 104. Hereinafter, each step in FIG. 8 will be described.

When the user 800 issues a data registration request (S811), a series of processing relating to the database registration is started in the computer 801. The computer 801 requests the input data from the storage device 101 (S812), and the storage device 101 returns the input data (S813). If the input data is the image, the computer 801 generates the 3D object (S814), and generates the images of the plurality of viewpoints from the input or generated 3D object (S815). The computer 801 extracts the feature from the image (S817), and requests registration in the 3D object and image database 112 in association with the 3D object (S818). The 3D object and image database 112 registers the data and issues a registration completion notification and the ID (S819). The computer 801 repeatedly executes the registration process for each image (S816), and when all the images have been registered, issues the registration completion notification to the user 800 (S820).

When the user 800 issues a data search request (S831), a series of processing related to the database search is started in the computer 801. The computer 801 requests the storage device 101 for query data (S832), and the storage device 101 returns the query data (S833). If the input data is the image, the computer 801 generates the 3D object (S834), and generates the images of the plurality of viewpoints from the input or generated 3D object (S835). The computer 801 extracts the feature from each of the images (S837), and performs the similar image search on the 3D object and image database 112 (S838). The 3D object and image database 112 returns image search results each including the reference 3D object ID and the similarity (S839). The computer 801 repeatedly executes the search process on each image (S836), calculates the similarity for each 3D object by integrating the similarities of the search results for the images (S840), and sorts the search results for the 3D objects in order of similarity and presents the search results to the user 800 (S841).

### Second Embodiment

The 3D object generation and search device 104 according to the first embodiment can acquire the similar 3D objects from the 3D object and image database 112 by generating the 3D object from the image, generating the images of the plurality of viewpoints, and performing the search. However, since it is necessary to accumulate the images of the plurality of viewpoints in the 3D object and image database 112, there is a problem that a size of database becomes large, or a search time becomes long because it is necessary to perform the search a plurality of times on the images of the plurality of viewpoints. When the images of the plurality of viewpoints are generated from the 3D object, the 3D object generation and search device 104 according to the second embodiment automatically selects representative images effective for the search to reduce the number of images used for registration or the search. Accordingly, it is possible to reduce the size of the database and speed up the search.

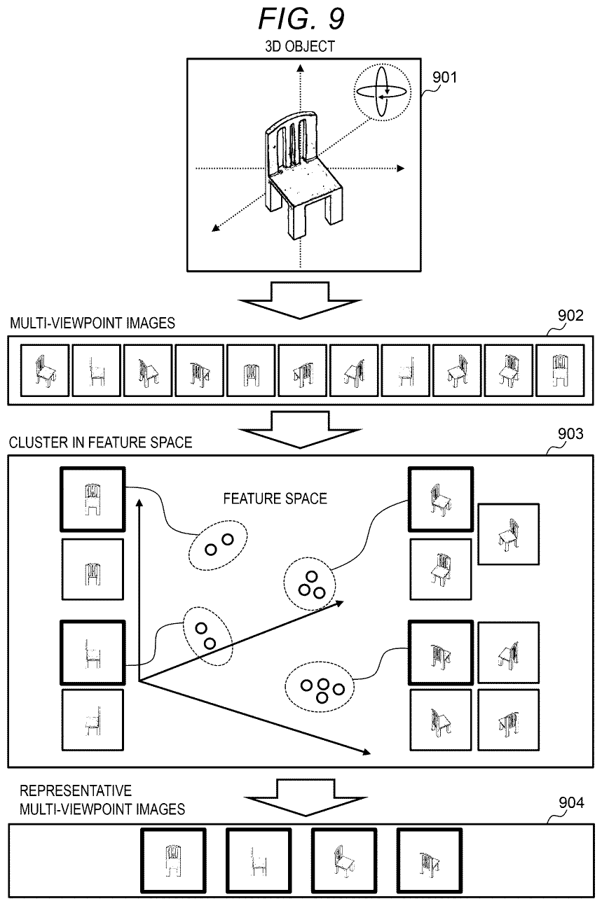

FIG. 9 is a diagram illustrating representative image selection performed by clustering in the 3D object generation and search device 104 according to the second embodiment. As in the first embodiment, multi-viewpoint images 902 are generated from input or generated 3D object 901. Next, image features are extracted from the generated images and clustered in a feature space (903). A clustering process is a process of classifying images having similar features into a group. As a clustering algorithm, k-means algorithm or the like can be used. The k-means algorithm is a process of classifying data points in a dataset into k predefined clusters. First, the algorithm randomly selects k cluster centers (centroids) from the dataset. Next, each data point is then assigned to a cluster based on a nearest centroid thereof, and a position of each centroid is updated based on an average position of the assigned data points. Processes of the assignment and the centroid updating are repeated until the cluster assignment remains stable or a predetermined number of iterations is reached.

Based on the above clustering 903, a predetermined number of representative images are selected from each group for the grouped multi-viewpoint images. As a selection method, for example, an image closest to a center of the cluster may be selected. As a result, a smaller number of representative images 904 than original multi-viewpoint images 902 are obtained. Since thinned images are similar to the representative images, it is expected that there will be no significant effect on searching accuracy. Further, as the selection method, a representative image may be selected based on an angle of the viewpoint. In this case, the closer the angle to the angle of input image, the more accurately the original features remain, making an image more suitable as the representative image. If the algorithm used for generating the 3D object can output the reliability, an image having high reliability may be selected as the representative image.

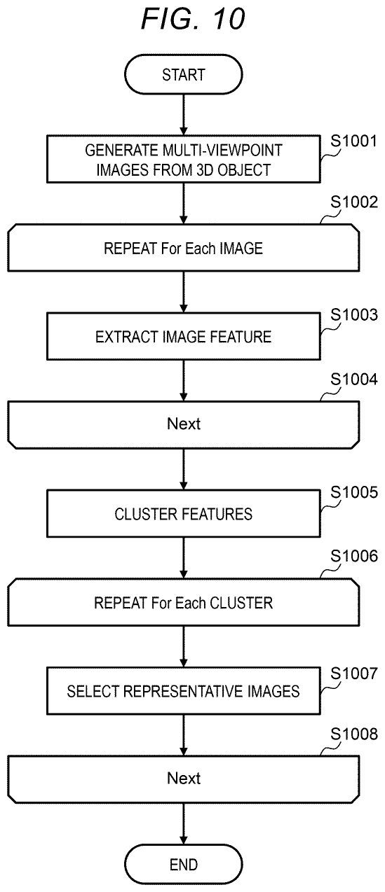

FIG. 10 is a diagram illustrating a process flow of the representative image selection performed by the clustering in the 3D object generation and search device 104 according to the second embodiment. Hereinafter, each step in FIG. 10 will be described.

The image generation unit 108 generates the multi-viewpoint images by providing the 3D object in the 3D space and performing rendering from cameras at a plurality of positions (S1001).

The 3D object generation and search device 104 executes step S1003 for each of the images generated in step S1001 (S1002).

The image feature extraction unit 110 calculates the image feature from the image (S1003).

When the features of all the images are extracted, the 3D object generation and search device 104 executes step S1005 (S1004).

The generated image evaluation unit 109 clusters the features extracted in step S1003 (S1005). For the clustering, any method such as a k-means algorithm can be used.

The 3D object generation and search device 104 executes step S1007 for each cluster obtained in step S1005 (S1006).

The generated image evaluation unit 109 selects a predetermined number of representative images from the cluster (S1007). For example, an image having a feature closest to a center vector of the cluster is selected.

When the representative images are selected from all the clusters, the 3D object generation and search device 104 combines the representative images and outputs the representative images as representative multi-viewpoint images of the 3D object, and ends the process (S1008).

In addition to clustering results, the 3D object generation and search device 104 according to the second embodiment can also select the representative images using a feature distribution of a reference image database.

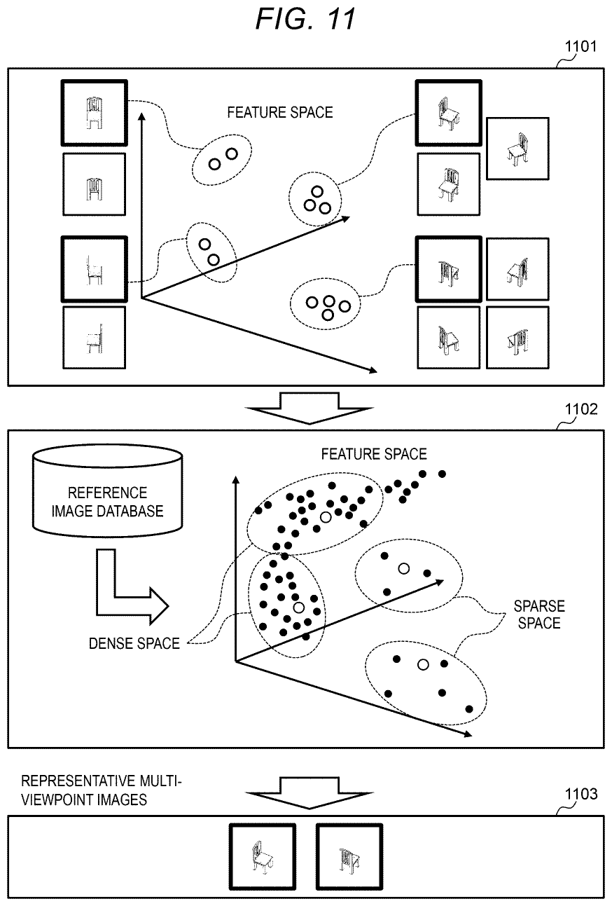

FIG. 11 is a diagram illustrating the selection of the representative images using the feature distribution of the 3D object generation and search device 104 according to the second embodiment. As described with reference to FIG. 9, when the clustering is used, the representative images can be selected from the multi-viewpoint images (1101). Next, a feature distribution around the features of the representative images is acquired from the reference image database in which multi-viewpoint images of a large number of 3D objects are uniformly registered (1102). In a case in which the representative images are present in a dense region on the feature space, since the representative images are likely to be common-looking images that are common to many 3D objects, it is difficult to obtain a desired image of a 3D object by a similar image search. On the other hand, in a case in which the representative images are in a sparse space, since the representative images are likely to be images having a unique appearance, it is easy to obtain a desired 3D object by the similar image search. Therefore, by narrowing down the images to the representative images (1103) that are present in the sparse region, the number of representative images associated with the 3D object can be reduced, further reducing the database size at the time of registration and a calculation cost at the time of search.

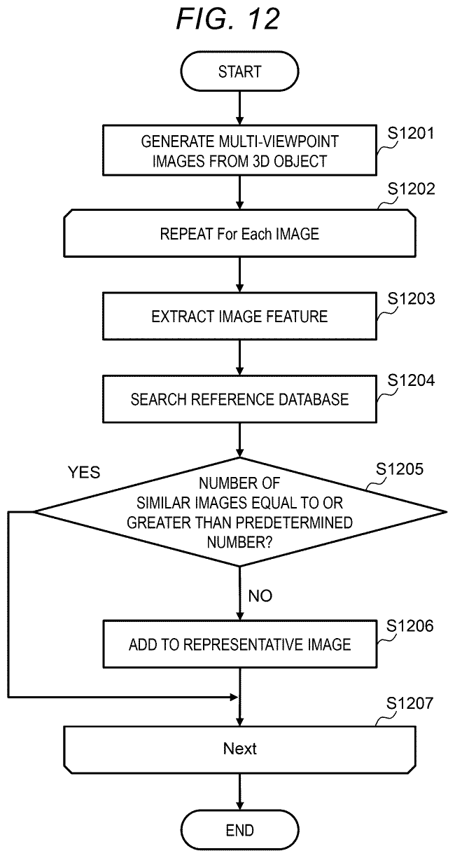

FIG. 12 is a diagram illustrating a process flow of the representative image selection using the feature distribution in the 3D object generation and search device 104 according to the second embodiment. Hereinafter, each step in FIG. 12 will be described.

The image generation unit 108 generates the multi-viewpoint images by providing the 3D object in the 3D space and performing rendering from the cameras at the plurality of positions (S1201).

The 3D object generation and search device 104 executes step S1206 for each of the images generated in step S1201 (S1202).

The image feature extraction unit 110 calculates the image feature from the image (S1203).

The image search unit 113 acquires images having a predetermined similarity or more from the 3D object and image database 112 using the features extracted in step S1203 as queries (S1204). At this time, since the feature distribution changes every time new data is registered, a reference image table may be stored in the 3D object and image database 112 in addition to the registration image table 310, and this table may be used as the search target.

If the number of similar images obtained in step S1204 is equal to or greater than the predetermined number, the generated image evaluation unit 109 determines that the images are common images present in a dense space and discards the images, and if not, executes step S1206 (S1205).

Since an image as an evaluation object is present in a sparse space, the generated image evaluation unit 109 determines that the image has a unique feature and adds the image to the representative image (S1206).

The 3D object generation and search device 104 ends the process if evaluation based on the feature distribution has been performed for all the images from the plurality of viewpoints (S1207).

The 3D object generation and search device 104 according to the second embodiment may perform the representative image selection using the clustering or the representative image selection using the feature distribution, or may perform the two methods.

### Third Embodiment

The 3D object generation and search device 104 according to the first embodiment performs a simple addition of the similarities of the same 3D object or a weighted addition using the weight specified by the user when the search results of the multi-viewpoint images are integrated. The 3D object generation and search device 104 according to the third embodiment automatically sets a weight of each of the search results using a position relationship of cameras and integrates the search results. Further, the 3D object generation and search device 104 according to the third embodiment can verify an integration process of the search results by using camera position information for 3D objects associated with search result images. Accordingly, accuracy of the search results of a 3D object can be improved.

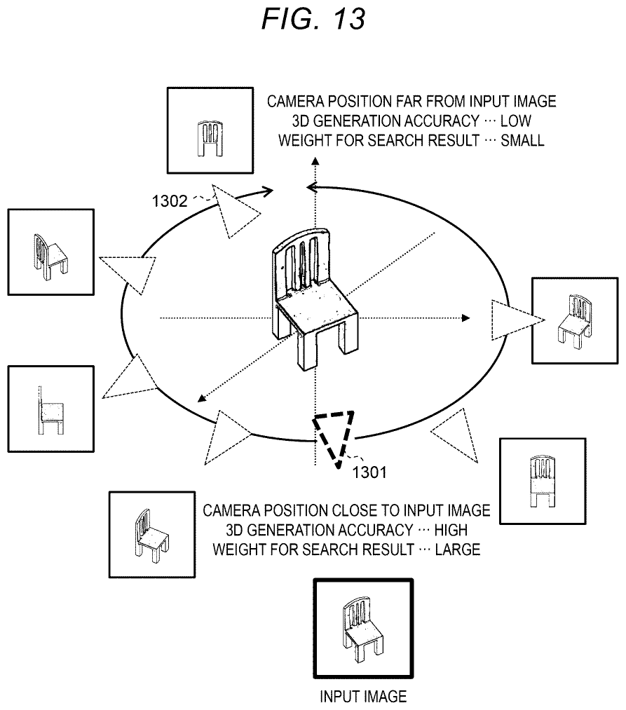

FIG. 13 is a diagram illustrating weighting of search results according to camera positions. The 3D object generation and search device 104 can obtain a 3D object from an input image by a 3D object generation model. At an angle of view equivalent to that of the input image, appropriate feedback is applied during a generation process, resulting in high accuracy of a corresponding part of a generated 3D model. On the other hand, for parts that are not shown in the input image, accuracy of 3D generation of those parts will be low because a probability of following random numbers or guesses is high. Therefore, when the generated 3D object is provided in the 3D space, a camera position of the input image is estimated, how much each of the multi-viewpoint images is moved or rotated from the camera position of the input image is calculated, and a weight when integrating the search results is set to be relatively low assuming that reliability is low for an image having a large movement amount or rotation amount.

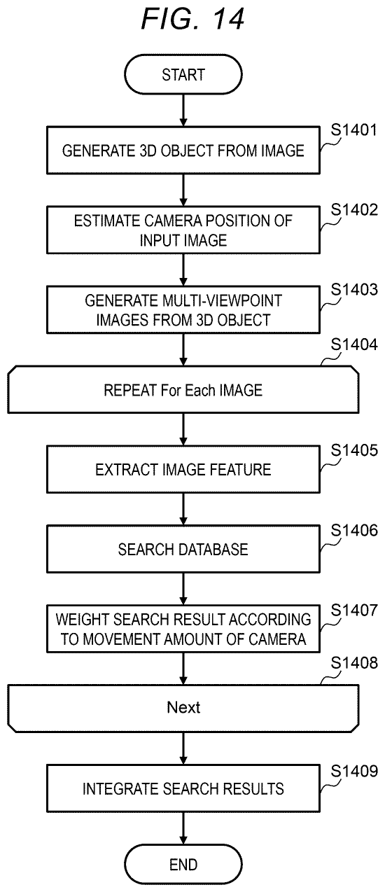

FIG. 14 is a diagram showing a process flow of weighting the search results according to the camera positions in the 3D object generation and search device 104 according to the third embodiment. Hereinafter, each step in FIG. 14 will be described.

The 3D object generation unit 107 generates the 3D object from the input image (S1401).

The 3D object generation unit 107 estimates the camera position of the input image by checking from which position an image close to the input image can be obtained by rendering when the 3D object is provided in the 3D space (S1402). Since the camera position of the input image may be determined in a 3D object generation algorithm, so this information may be output from the algorithm.

The image generation unit 108 generates the images of the plurality of viewpoints from the 3D object generated in step S1401 (S1403).

The 3D object generation and search device 104 executes step S1405 to step S1407 for each of the images generated in step S1403 (S1404).

The image feature extraction unit 110 calculates the image feature from the image (S1405).

The image search unit 113 searches the 3D object and image database for the similar images using the image features calculated in step S1405 (S1406).

The image search result integration unit 114 calculates the movement amount of the camera from a camera position of an image of a search query and the camera position of the input image acquired in step S1402, and determines a weight of the search result according to the movement amount (S1407).

When the search process has been executed for all the images, the 3D object generation and search device 104 executes step S1409 (S1408).

The image search result integration unit 114 calculates the similarities for each 3D object by using image search results acquired in step S1406 and the weight for each of the search results determined in step S1407, sorts and outputs the search results in descending order of a total similarity, and ends the process (S1409).

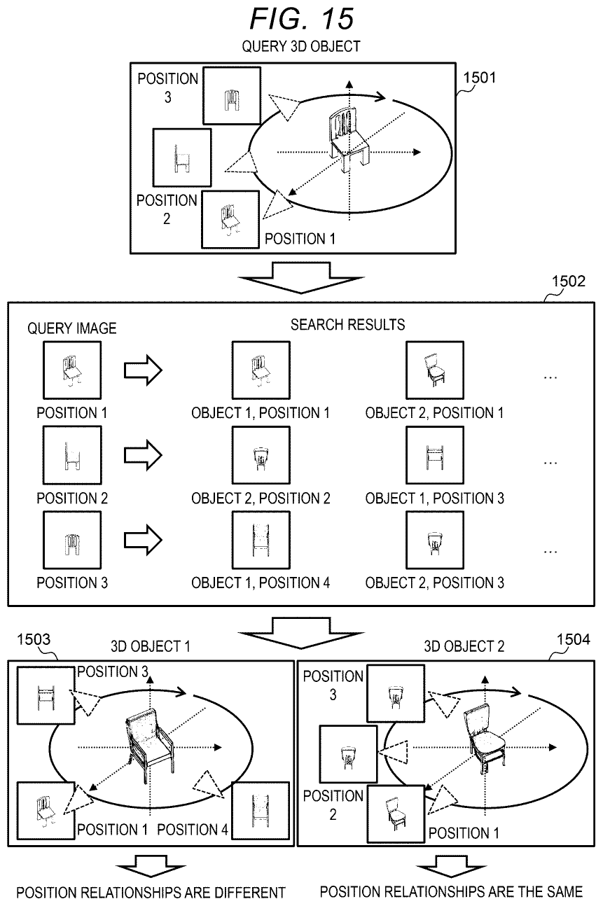

FIG. 15 is a diagram illustrating the verification of camera position relationships between a query and the search results. In this example, images at camera positions 1, 2, and 3 are generated from the 3D object of the query (1501). Using each image as a query, similar images are acquired from the 3D object and image database 112. At this time, in addition to values of the ID field 313 of the reference 3D object, values of the camera position field 315 are acquired from the image table 310 (1502).

The image search result integration unit 114 integrates the image search results for each 3D object, and verifies whether a position relationship of a query image set in the 3D space matches a position relationship of a search result image set in the 3D space. For example, for a 3D object 1 of 1503, images at a camera position 1, a position 3, and a position 4 appear in the search results, and the images from positions different from the query happen to be similar, so there is a high possibility that 3D structures are different. On the other hand, for a 3D object 2 of 1504, images having the same position relationship as the query appear in the search results, and the 3D structures are likely to be closer. As described above, searching accuracy is improved by adjusting the total similarity using identity of the position relationships of the images.

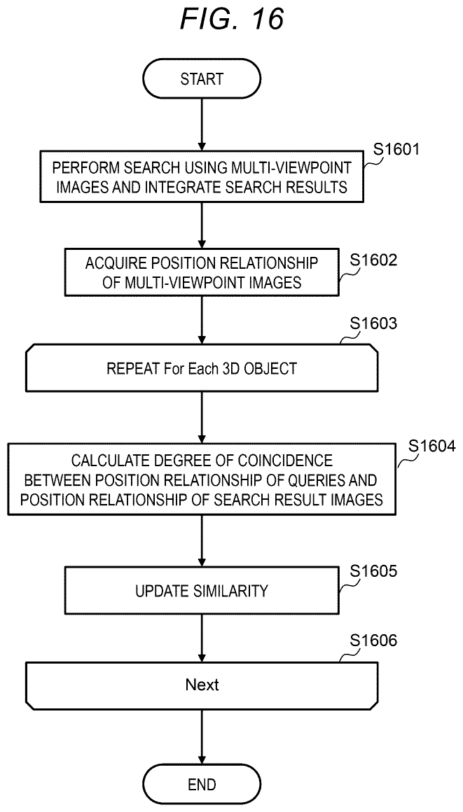

FIG. 16 is a diagram illustrating a process flow of verifying camera position relationships between the query and the search results. Hereinafter, each step in FIG. 16 will be described.

The 3D object generation and search device 104 perform the search using multi-viewpoint images, integrates the image search results, and outputs the search results of the 3D objects (S1601). This corresponds to the database search process in FIG. 6.

The image search result integration unit 114 acquires the position relationship of the multi-viewpoint images of the query in the 3D space (S1602). This can be easily acquired from camera parameters used by the image generation unit 108 to render the 3D object.

The 3D object generation and search device 104 executes step S1604 and step S1605 for each of the search results of the 3D object acquired in step S1601 (S1603).

The image search result integration unit 114 acquires the camera position information from the image search results regarding the target 3D object, and calculates a degree of coincidence between positions of query images and positions of the search result images (S1604).

The search result integration unit 114 updates a value of the total similarity calculated in step S1601 with the degree of coincidence of each of the position relationships calculated in step S1604 (S1605). For example, when the degree of coincidence is 50%, a value obtained by multiplying the total similarity by 0.5 is set as a total similarity after the update.

When the verification of the position relationship and the update of the total similarity have been executed for all the 3D objects, the 3D object generation and search device 104 ends the process (S1606).

### Fourth Embodiment

The 3D object generation and search device 104 according to the first embodiment generates the images for search by rendering the 3D object of the search query from the plurality of viewpoints in the 3D space. By handling the search query in the 3D space, it is possible to process the search images in various ways in addition to changing the viewpoint. The 3D object generation and search device 104 according to a fourth embodiment renders the object provided in the 3D space by a plurality of methods, and generates high-quality images from an image generation model that uses a multi-modal image as input. Further, by providing a plurality of 3D objects in the 3D space, it is possible to search for a composite object. Accordingly, searching accuracy and search flexibility are improved.

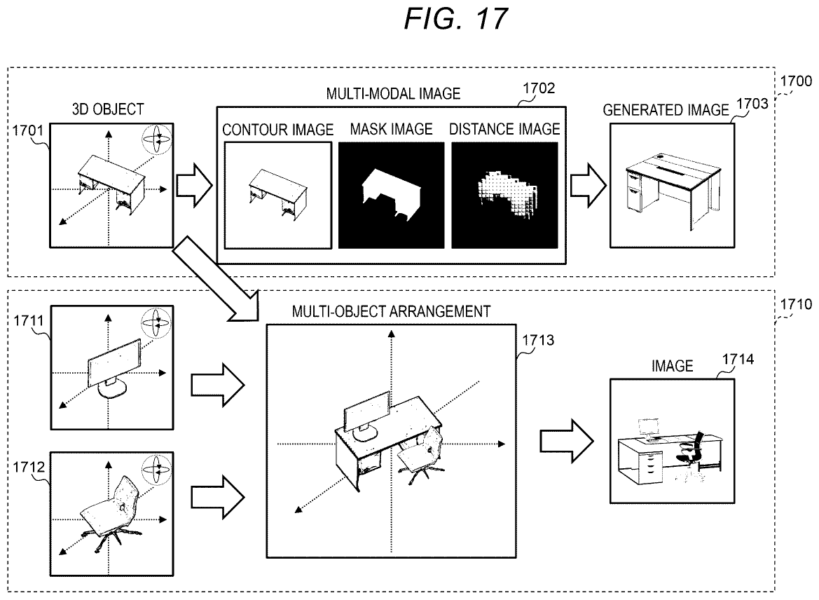

FIG. 17 is a diagram illustrating query image generation performed by multi-modal/multi-object in the 3D object generation and search device 104 according to the fourth embodiment. Processing in an upper portion 1700 of the figure is the query image generation using the multi-modal image. After the 3D object 1701 of the search query is provided in the 3D space, a general 3D drawing engine can output not only a normal image but also the multi-modal image (1702). For example, a contour image in which only a contour line of an object is left, a mask image in which an object region is filled with a single color, a distance image in which a position from a camera is expressed in gray scale, or the like can be acquired. A method for generating a new high-quality image from an image by using the image generation model is already known. Further, a method in which a contour image, a mask image, and a distance image are given as control information to change a texture and a detail while maintaining an outline of the object is also known. By using such a method, a high-quality generated image can be obtained (1703).

That is, the searching accuracy can be improved by generating the multi-modal image from the 3D object generated using a predetermined algorithm or the like, generating an image from the multi-modal image, and using the image generated from the multi-modal image for the search.

Processing in a lower part 1710 in FIG. 17 is query image generation performed using a multi-object. In the general 3D drawing engine, a plurality of 3D objects can be provided at any positions in the 3D space, and any rotation can be performed. In this example, 3D objects 1701, 1711, and 1712 are input to create a 3D space in which a plurality of objects are provided (1713).

In a multi-object in which the plurality of objects are provided, the search can be performed taking into account a relationship with other objects, thereby improving the searching accuracy.

Either the arrangement of the multi-object or the image generation process using the multi-modal image may be applied, or the image generation process using the multi-modal image may be performed on the 3D space in which the multi-object is provided.

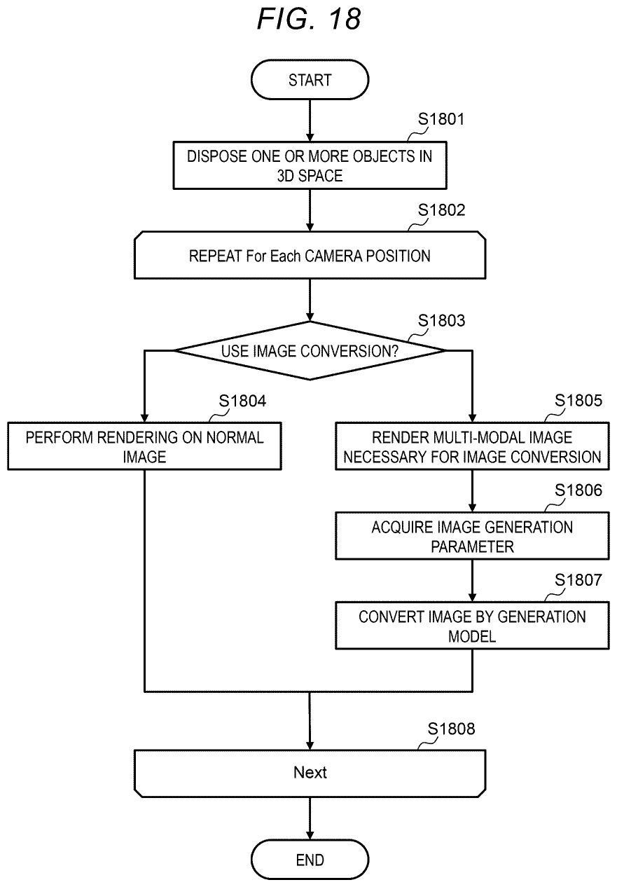

FIG. 18 is a diagram illustrating a process flow of the query image generation performed by multi-modal/multi-object in the 3D object generation and search device 104 according to the fourth embodiment. Hereinafter, each step in FIG. 18 will be described.

The image generation unit 108 provides one or more objects in the 3D space (S1801). A position and rotation of each of the objects in the 3D space can be specified by a user using the input device 102.

The 3D object generation and search device 104 executes step S1803 to step S1808 for camera positions for generating a plurality of images (S1803).

The image generation unit 108 executes step S1805 when processing using the multi-modal image is performed, and executes step S1804 if not (S1804).

The image generation unit 108 performs the rendering on the normal image (S1804).

The image generation unit 108 renders the multi-modal image necessary for image conversion (S1805). For example, a contour image, a mask image, a distance image, or the like can be rendered.

The image generation unit 108 acquires a parameter to be given to the image generation model (S1806). For example, in a method for generating a new image by providing the multi-modal image and sentence prompts, the sentence is taken as the parameter.

The image generation unit 108 inputs the multi-modal image acquired in step S1805 and the parameter acquired in step S1806 to the image generation model to convert these into a high-quality image (S1807).

When the image generation has been executed for all the camera positions, the 3D object generation and search device 104 ends the process (S1808).

As described above, a search system disclosed in the embodiments includes: the 3D object generation unit 107 configured to generate an input 3D object from an input image; the image generation unit 108 configured to generate, as a search image group, a plurality of images obtained by viewing the input 3D object from a plurality of viewpoints; the image feature extraction unit 110 configured to calculate an image feature from each of the images in the search image group; the image search unit 113 configured to search, by using each of the images in the search image group as a search query, a database in which a plurality of images obtained by viewing a plurality of 3D objects as search targets from a plurality of viewpoints are registered; and the image search result integration unit 114 configured to integrate a search result for each of the images in the search image group for each of the 3D objects as the search targets, and output, as a similar 3D object, a 3D object similar to the input image among the 3D objects as the search targets.

Therefore, by generating the 3D object from the input image given by the user, generating the images of the plurality of viewpoints from the generated 3D object, searching the database using the plurality of images as the queries, and integrating the plurality of search results, it is possible to output the 3D objects similar in appearance to the input image.

By using the multi-viewpoint images, it is possible to obtain highly accurate search results as compared with a case in which the search is performed only from a single viewpoint. Further, it is not necessary to learn the feature according to the object. Further, the user can give feedback to the search by viewing and editing the generated 3D object on the 3D space, viewing and processing the image used for the search, and controlling the weighting in the integration of the search results.

Therefore, it is possible to achieve a highly convenient search system capable of performing search feedback without a learning load in searching for the 3D object.

Specifically, each of the images registered in the database is associated with identification information of the 3D object as the search target, the image search unit 113 obtains a similarity to the search query for a plurality of images which are search results for the search query, and the image search result integration unit 114 adds up similarities of images associated with identification information of the same 3D object from search results of each of the images in the search image group to obtain a similarity of the 3D object.

With this processing, the search system can easily obtain the similarity of the 3D object.

The image search result integration unit 114 adds up the similarities of the images associated with the identification information of the same 3D object are by applying a predetermined weight, and the weight is determined according to a difference between a viewpoint of each of the images included in the search image group and a viewpoint of the input image.

Therefore, the search can be performed for the 3D object generated from the input image by considering from which viewpoint the object is most accurate.

The disclosed search system further includes: the display unit 115 configured to display the input image and the images in the search image group; and the input unit 102 configured to receive specification of a weight for the images in the search image group, in which the image search result integration unit 114 adds up the similarities of the images associated with the identification information of the same 3D object by applying the specified weight.

Therefore, the user can check the 3D object generated from the input image and perform the search by considering from which viewpoint the feature of the object becomes apparent.

The disclosed search system further includes: the registration unit 111 configured to register images in the database, in which when an image is received as the search target, the 3D object generation unit 107 generates a 3D object as the search target, the image generation unit 108 uses a 3D object received as the search target or the 3D object generated from the image received as the search target to generate a plurality of images obtained by viewing the 3D object from a plurality of viewpoints as a registration image group, and the registration unit associates the image group generated by the image generation unit 108 with identification information of the 3D object as the search target, and registers the image group in the database.

Therefore, it is possible to generate the 3D object from the image and register the images of the plurality of viewpoints in the database.

The database associates 3D object identification information with 3D object data indicating a 3D object as the search target, and associates the 3D object identification information, an image feature, and a viewpoint position with image data indicating an image as the search target.

Therefore, it is possible to collectively manage a relationship between data related to the 3D object and the image data generated from the 3D object.

As an example, the image search unit 113 searches for a representative image among the images registered in the database, and the representative image is selected for each cluster obtained by dividing a feature space.

In this configuration, it is possible to avoid searching images having overlapping features and to perform an efficient search.

As an example, the image search unit 113 searches for a representative image among the images registered in the database, and the representative image is an image present in a region where density is less than a threshold in a feature space.

In this configuration, the efficient search can be performed by searching for the images in which the feature of the 3D object is visualized.

Further, the image search result integration unit 114 corrects, according to a degree of coincidence between a combination of the viewpoints in the search image group and a combination of viewpoints in the images associated with the identification information of the same 3D object, the similarity of the 3D object as the search target.

In this configuration, a highly accurate search is possible by considering the combination of viewpoints.

The image generation unit 108 generates a multi-modal image from the input 3D object, and outputs an image generated from the multi-modal image as an image in the search image group.

In this configuration, the plurality of features are extracted from the multi-modal image, an image is configured from the extracted features, and the configured image is used as the search query, so that the searching accuracy is improved.

The 3D object generation unit 107 combines a plurality of 3D objects, and the image generation unit 108 generates a plurality of images obtained by viewing a combination of the plurality of 3D objects from a plurality of viewpoints as a search image group.

In this configuration, it is possible to perform a highly accurate search in consideration of a relationship with another object.

The embodiments according to the invention have been described above.

The invention is not limited to the embodiments described above, and includes various modifications. For example, the embodiments described above have been described in detail to facilitate understanding of the invention, and the invention is not necessarily limited to those including all the described configurations. A part of a configuration in one embodiment can be replaced with a configuration in another embodiment, and a configuration in one embodiment can also be added to a configuration in another embodiment. A part of a configuration of each embodiment may be added to, deleted from, or replaced with another configuration.

A part or all of the configurations, functions, processing units, processing methods, and the like described above may be implemented by hardware by, for example, designing with an integrated circuit. In addition, the above configurations, functions, and the like may be implemented by software by a processor interpreting and executing a program for implementing each function. Information such as a program, a table, and a file for implementing each function can be stored in a recording apparatus such as a memory, a hard disk, or a solid state drive (SSD), or in a recording medium such as an IC card, an SD card, or a DVD.

Further, control lines and information lines indicate what is considered to be necessary for description, and not necessarily all control lines and information lines are always shown on a product. Actually, almost all configurations may be considered to be connected.

What is claimed is:

1. A search system comprising:
a 3D object generation unit configured to generate an input 3D object from an input image;
an image generation unit configured to generate, as a search image group, a plurality of images obtained by viewing the input 3D object from a plurality of viewpoints;
an image feature extraction unit configured to calculate an image feature from each of the images in the search image group;
an image search unit configured to search, by using each of the images in the search image group as a search query, a database in which a plurality of images obtained by viewing a plurality of 3D objects as search targets from a plurality of viewpoints are registered; and
an image search result integration unit configured to integrate a search result for each of the images in the search image group for each of the 3D objects as the search targets, and output, as a similar 3D object, a 3D object similar to the input image among the 3D objects as the search targets.

2. The search system according to claim 1, wherein
each of the images registered in the database is associated with identification information of the 3D object as the search target,
the image search unit obtains a similarity to the search query for a plurality of images which are search results for the search query, and
the image search result integration unit adds up similarities of images associated with identification information of the same 3D object from search results of each of the images in the search image group to obtain a similarity of the 3D object.

3. The search system according to claim 2, wherein
the image search result integration unit adds up the similarities of the images associated with the identification information of the same 3D object by applying a predetermined weight, and
the weight is determined according to a difference between a viewpoint of each of the images included in the search image group and a viewpoint of the input image.

4. The search system according to claim 2, further comprising:
a display unit configured to display the input image and the images in the search image group; and
an input unit configured to receive specification of a weight for the images in the search image group, wherein
the image search result integration unit adds up the similarities of the images associated with the identification information of the same 3D object by applying the specified weight.

5. The search system according to claim 1, further comprising:
a registration unit configured to register images in the database, wherein
when an image is received as the search target, the 3D object generation unit generates a 3D object as the search target,
the image generation unit uses a 3D object received as the search target or the 3D object generated from the image received as the search target to generate a plurality of images obtained by viewing the 3D object from a plurality of viewpoints as a registration image group, and
the registration unit associates the image group generated by the image generation unit with identification information of the 3D object as the search target, and registers the image group in the database.

6. The search system according to claim 1, wherein
the database associates 3D object identification information with 3D object data indicating a 3D object as the search target, and associates the 3D object identification information, an image feature, and a viewpoint position with image data indicating an image as the search target.

7. The search system according to claim 1, wherein
the image search unit searches for a representative image among the images registered in the database, and
the representative image is selected for each cluster obtained by dividing a feature space.

8. The search system according to claim 1, wherein
the image search unit searches for a representative image among the images registered in the database, and
the representative image is an image present in a region where density is less than a threshold in a feature space.

9. The search system according to claim 2, wherein
the image search result integration unit corrects, according to a degree of coincidence between a combination of the viewpoints in the search image group and a combination of viewpoints in the images associated with the identification information of the same 3D object, the similarity of the 3D object as the search target.

10. The search system according to claim 1, wherein
the image generation unit generates a multi-modal image from the input 3D object, and outputs an image generated from the multi-modal image as an image in the search image group.

11. The search system according to claim 1, wherein
the 3D object generation unit combines a plurality of 3D objects, and
the image generation unit generates a plurality of images obtained by viewing a combination of the plurality of 3D objects from a plurality of viewpoints as a search image group.

12. A search method comprising:
by a search device,
a 3D object generation step of generating an input 3D object from an input image;
an image generation step of generating, as a search image group, a plurality of images obtained by viewing the input 3D object from a plurality of viewpoints;
an image feature calculation step of calculating an image feature from each of the images in the search image group;
an image search step of searching, by using each of the images in the search image group as a search query, a database in which a plurality of images obtained by viewing a plurality of 3D objects as search targets from a plurality of viewpoints are registered; and
an image search result integration step of integrating a search result for each of the images in the search image group for each of the 3D objects as the search targets, and outputting, as a similar 3D object, a 3D object similar to the input image among the 3D objects as the search targets.
